(19) United States
(12) Patent Application Publication
(10) Pub. No.: US 2024/0016336 A1
(43) Pub. Date: Jan. 18, 2024

(54) MODULAR MULTIPURPOSE COOKING SURFACE AND SMOKING TRAY

(71) Applicant: Nexgrill Industries, Inc., Chino Hills, CA (US)

(72) Inventors: Sherman Lin, Chino Hills, CA (US); Andre de Beer, Tustin, CA (US); Wilfrido Barajas, JR., Chino, CA (US)

(21) Appl. No.: 17/812,355

(22) Filed: Jul. 13, 2022

(51) Int. Cl. A47J 37/06; A47J 37/07

(52) U.S. Cl. CPC A47J 37/0694; A47J 37/067; A47J 37/0786

(57) ABSTRACT

System involved with but not limited to an apparatus including a cooking system capable of multiple food preparation configurations, including but not limited to grilling, smoking, and griddling. The disclosed apparatus may add functionality to a pre-existing heat source, such as a barbecue grill, and may be comprised of a solid metal member and a metal grate adapted for placement in overlying relation to said metal member. Said solid metal member may function as a griddle or as a tray onto which flavoring agents, such as wood chips, may be placed to be heated to a smoldering temperature, enabling the user to smoke food items. An opening may be disposed in said metal grate into which cooking accessories, such as a wok or basket, may be received. Additionally, other aspects are described in the claims, drawings, and text forming a part of the present disclosure.

### TECHNICAL FIELD

Embodiments of the present disclosure relate generally to multifunctional and modular outdoor cooking accessories. More specifically, aspects of the present disclosure relate to a multipurpose metal assembly capable of being placed by a user over a heat source to cook foods in the same manner as a barbecue grill, griddle, or smoker, depending on the configuration employed by the user. When smoking, the disclosed apparatus may be adapted to transfer heat from a heat source to wood chips, causing the chips to smolder and generate smoke beneath and in close proximity to foods cooked on a grate disposed over the tray, which in turn adds additional flavor character to food items cooked using the disclosed apparatus. The disclosed apparatus may also be capable of receiving a number of modular cooking accessories such as a griddle, wok, grill pan, pizza stone or sear grid.

### BACKGROUND

Outdoor cooking is a popular tradition in much of the world. Outdoor cooking may be achieved via various modes, but the most common systems utilized for cooking outdoors are barbeque grills, which are devices that cook food by providing heat in an area below a grill or grate. The heat is often provided via two methods: (1) a gas fuel, such as propane, or (2) a solid fuel such as wood and/or charcoal. Other modes include electrical heating elements. These two types of barbeque grills are generally referred to as “gas grills” or “charcoal grills.”

A griddle is a cooking device that is used in both residential and commercial applications for a range of cooking methods. A griddle is commonly a metal plate made of cast or wrought iron, aluminum, or steel. Griddles, which have experienced recent gains in popularity, may be heated by open flame or electrical elements, directly or indirectly. Griddles allow users to apply heat evenly across a cooking surface and allow for small foods, such as rice and corn kernels, to be heated without falling through a grate. Griddles also allow users to prevent grease from falling onto a heat source, thereby enabling the user to maintain a greater degree of control over fuel available for generating heat and smoke.

Smoking is another common practice of cooking food items over an indirect, smoke-producing heat source for extended periods of time, which imparts a unique, smoky flavor into foods cooked using this method. Smoking also refers to preserving meat through even more prolonged exposure to heat and smoke, which preserves and imparts antimicrobial qualities unto the meat. In the context of this disclosure, “smoking” is meant to refer to the practice of applying smoke to a cooking food item in order to imbue it with smoke flavoring. As meats and other food items are exposed to smoke generated by burning wood, they absorb elements of the smoke which alters their flavor. Specifically, smoking applies a number of substances found in woods to smoked foods, including syringol, which supplies a smoky taste, and guaiacol, which supplies a smoky aroma. Concentrations of these substances vary across different varieties of woods, and can result in different, more complex flavor profiles depending on the type and amount of wood used, the amount of moisture present in the wood, the amount of time the food is exposed to the smoke, and other variables in smoking articles of food.

Many backyard cooks own multiple cooking appliances, such as a barbeque grill, a dedicated smoker, and/or a dedicated griddle, to enable the use of each of the cooking methods described above. The present disclosure eliminates the need to own each appliance in order to cook food items using a grill, griddle, or smoker by providing a modular cooking tool that may be used to cook food via grill, griddle, or smoking. The present disclosure also provides an advantage over known methods of utilizing wood chips in conjunction with barbecue grills, such as placing wetted wood chips onto lit charcoal. The disclosed apparatus also enables the burning of wood chips with a gas grill to obtain a smoky flavor; ordinary gas grills do not feature any apparatus for placing wood chips between the heat source and the cooking surface in order to smoke food items. The disclosed apparatus also enables a convenient means for users to be able to use a griddle cooking surface with a gas or charcoal grill with either a flat surface or a solid surface with raised ridges that can provide char marks on cooked foods in order to enhance food presentation. In another embodiment of the present disclosure, a section of the grate may be removed to enable the product to receive additional modular cooking accessories, including but not limited to a griddle, pizza stone, sear grid, grill pan, poultry roaster, wok, panini press or shaker basket to enable the user to utilize multiple cooking method simultaneously from a single heat source.

### SUMMARY

It is an object, feature, and/or advantage of the present disclosure to provide outdoor cooking accessory that overcome deficiencies in the prior art. A modular, multipurpose cooking surface and smoking tray provides advantages over prior art, giving users a number of cooking options to use alone or in combination with existing cooking surfaces provided by a barbecue grill or other heat source. A heat source capable of generating sufficient heat may be used in combination with the disclosed apparatus to cook or smoke meats and other food items in a variety of ways.

The present disclosure features multiple configurations such that the solid metal member providing a heat transfer zone may be used as a griddle or grill pan cooking surface, or it may hold and transfer heat to burnable flavoring agents, such as wood chips, and function as a smoking apparatus. The components of the disclosed apparatus are easily removable from the heating source and are consequently portable and may be easily cleaned.

Additionally, when the solid member is used as a smoking tray, the charred remnants of any burnable flavoring agents may be easily collected for disposal. Whether used as a smoking tray or as a cooking surface, the solid member of the disclosed apparatus also allows diffused heat to be evenly applied to food items being cooked. When used in a smoking configuration, the disclosed apparatus also allows meats and other food items to be cooked in close proximity to the burnable flavoring agents that produce a desirable smoky flavor and aroma, thereby improving flavor outcomes.

Moreover, this mode of smoking may be applied to any number of food items through the use of modular attachments. For example, by using a mesh shaker basket accessory, a user is able to smoke small food items like corn kernels that would otherwise need to be wrapped in foil to prevent them from falling through a grate. Other food items that are optimally cooked on a solid surface are also able to maximize exposure to smoke during cooking by utilizing modular accessories. For example, a pizza may be cooked on a pizza stone accessory placed in the seat of the opening of the cooking grate while smoke is able to rise through the opening in the grates surrounding the opening.

In accordance with one exemplary aspect, a cooking system is provided having a multifunctional solid metal member capable of receiving a separate grated cooking surface. A solid metal member is adapted for placement in overlying relation to a heat source, typically provided by a charcoal or gas burning barbecue grill. An exemplary solid member has a flat, planar upper side and a planar underside with a plurality of raised ridges. This exemplary metal member provides a heat transfer zone. The upper side defines a cooking surface wherein heat is transferred from the heating source to the food product. The underside also defines a cooking surface with raised ridges wherein heat is transferred from the heating source to the food product. A grated cooking surface is adapted for placement in overlying relation to the solid metal member; the solid metal member is in turn adapted to receive the grated cooking surface.

An upper side of a solid metal member may include upwardly extending side walls defining a tray capable of holding wood chips or other burnable flavoring agents. The solid metal member may be capable of receiving a cooking grate, optionally via pegs disposed near the corners of the grate that may be placed into holes disposed in corresponding locations on the solid member.

When used for smoking, burnable flavoring agents may be placed on the heat transfer zone of the solid metal member, and the cooking grate may be placed in overlying relation to the solid metal member upon which the burnable flavoring agents have been placed. When the grated surface is placed onto the solid metal member, a smoking assembly is formed. The smoking assembly may be placed over a heat source, typically a firebox provided by a gas or charcoal grill. The smoking assembly may alternatively be placed onto a gas or charcoal grill's existing grate, or in place of the grill's grate when dimensions of the grill housing allow. The heat source may apply heat to the underside of the smoking assembly, which transfers the heat upward to burnable flavoring agents placed on the solid metal member, the cooking grate disposed in overlying relation thereon. Food items to be cooked may be placed on the cooking grate. The heat causes the burnable flavoring agents to smolder, thereby producing smoke directly under and within close proximity to food items placed on the cooking grate.

The solid metal member may also be used as a griddle or grill pan. The metal member may be placed on the existing grate of a barbecue grill or the edges of the containment housing of the firebox of a barbecue grill, if the dimensions of the containment housing allow. The smooth, flat side of the solid metal member faces upward when the plate is used as a griddle, and the side with raised ridges faces upward when then plate is used as a grill pan, or when the user desires to cook grill marks onto the food being prepared.

The cooking grate may be adapted to receive one or a plurality of modular accessories. A cooking grate may have a rectangular opening with flanges extending from the underside of the opening disposed around the perimeter of said opening. The flanges define a seat upon which a fitted cooking grate may be set such that the cooking grate provides a continuous planar cooking surface. Alternatively, the flanges may define a seat upon which fitted cooking accessories may be placed such that they may be held in a fixed location in close proximity to the smoking tray disposed in underlying fashion to the cooking grate. In this configuration, food items may be placed within or on top of said cooking accessories and cooked in close proximity to any burnable flavoring agents capable of generating smoke when smoldered. Cooking in this manner maximized exposure to smoke generated by the burnable flavoring agents. Modular cooking accessories, include but are not limited to a griddle, pizza stone, sear grid, grill pan, poultry roaster, wok, panini press and/or shaker basket.

### BRIEF DESCRIPTION OF THE DRAWINGS

The accompanying drawings, which are incorporated in, and which constitute a part of this specification, illustrate exemplary constructions and procedures in accordance with the present disclosure and, together with the general description of the disclosure given above and the detailed description set forth below, serve to explain the principles of the disclosure wherein:

FIG. 1 is a top view of an exemplary a solid member capable of receiving a grilling grate, receiving wood chips for smoking, and acting as a griddle cooking surface;

FIG. 2 is a perspective view of the exemplary solid member in FIG. 1;

FIG. 3 is a bottom view of the exemplary solid member of FIGS. 1 and 2 with raised grill ridges;

FIG. 4 is a cut away lateral view of the exemplary solid member of FIGS. 1, 2, and 3;

FIG. 5 is a lateral view of the exemplary solid member of FIGS. 1, 2, 3 and 4;

FIG. 6 is a top view of an exemplary grate member capable of being received by the exemplary solid member of FIGS. 1-5;

FIG. 7 is a perspective view of the exemplary grate member of FIG. 6; and

FIG. 8 is a cut away lateral view of the exemplary grate member of FIGS. 6 and 7.

While constructions consistent with the present disclosure have been illustrated and generally described above and will hereinafter be described in connection with certain potentially preferred embodiments and practices, it is to be understood that in no event is the disclosure limited to such illustrated and described embodiments and practices. On the contrary, it is intended that the present disclosure shall extend to all alternatives and modifications as may embrace the general principles of this disclosure within the full and true spirit and scope thereof. Also, it is to be understood that the phraseology and terminology used herein are for purposes of description only and should not be regarded as limiting. The use herein of terms such as “including” and “comprising” and variations thereof is meant to encompass the items listed thereafter and equivalents thereof as well as additional items and equivalents thereof.

### DETAILED DESCRIPTION

In accordance with one exemplary aspect, a cooking system is provided having a multifunctional solid metal member capable of receiving a separate grated cooking surface. A solid metal member is adapted for placement in overlying relation to a heat source, typically provided by a charcoal or gas burning barbecue grill. The solid metal member may be placed on top of or in place of the grate of a provided charcoal or gas burning barbecue grill.

An exemplary solid member is rectangular in shape, having a flat, smooth, and planar upper side and a planar underside with a plurality of raised ridges. Each side may function as a cooking surface while facing upward toward the user; for purposes of clarity, the smooth side shall herein be referred to as the ‘upper’ side while the side featuring raised grill ridges shall be referred to as the ‘under’ side. The upper side and under side each define a cooking surface. The solid member may include a raised perimeter wall extending upwardly from the upper side, or downwardly from the lower side, or both.

An exemplary solid member may be adapted to receive a cooking grate in overlying relation to the planar surface of the solid member. In an exemplary, non-limiting embodiment, metallic cylindrical pegs may extend downward from a cooking grate while corresponding round openings capable of receiving the pegs of the cooking grate may be disposed near the corners of the solid member. The openings may be disposed in the planar surface of the solid member or in the raised perimeter wall. Alternatively, round cylindrical pegs may extend from the surface(s) of the solid member while corresponding openings disposed in the grate allow the grate to be securely set in overlying relation to the solid member. Pegs may be cylindrical or rectangular.

An exemplary solid member may be adapted for placement on a barbecue grill in a side-by-side configuration with one or a plurality of cooking grates. A plurality of notches may be disposed along a perimeter edge of an exemplary solid member. A notch in this context is understood to mean an indentation defining a space extending vertically through the planes of the cooking surface and perimeter wall(s) in the perimeter of the solid member. The notches in the perimeter of the solid member may correspond to portions of the bars of the cooking grate extending beyond the perimeter edge of the cooking grate, such that when the perimeter wall of the exemplary solid member containing a plurality of notches is placed adjacent to a perimeter edge of an exemplary cooking grate containing a corresponding plurality of grate bar extensions, the portion of the grate bars extending beyond the perimeter of the cooking grate fit into corresponding notches of the solid member. In this configuration, the perimeter walls of the grate and solid member may be placed in close proximity such that food items are less likely to fall into the gap between them and such that positions of the member and grate are secured with respect to one another.

An exemplary cooking grate is configured to be placed in overlying relation to an exemplary solid metal member. The cooking grate may be rectangular in shape with dimensions that allow the grate to cover the entire surface of the solid metal member. The cooking grate may include metallic pegs extending downward from the planar underside of the cooking grate. The pegs, which may be cylindrical or rectangular, may be set into corresponding holes of the solid metal member such that the grate may be securely placed onto the solid metal member. A plurality of the metal bars defining the grate may extend beyond the perimeter of the grate such that when the grate is placed level with and adjacent to the solid metal member, the bars may fit into the notches disposed in the perimeter edge of the solid metal member, thereby allowing the corresponding perimeter edges of the respective solid metal member and cooking grate to be placed in close proximity and secured with respect to one another. An opening may optionally be disposed in the grate to allow the grate to be lifted when not in use for cooking.

The width of the notches in the perimeter of the solid member may decrease from the upper side of the solid member to the underside of the solid member to allow the bars extending beyond the perimeter of the grate to be more easily dropped into place and secured.

An opening may optionally be disposed in the center of the grate to allow cooking accessories to be securely received at the opening. The perimeter of an exemplary grate is defined by metallic bars forming a rectangular opening in the planar cooking surface of the cooking grate. A metallic flange extends from the bottom surface of the perimeter of the opening of the grate that is capable of functioning as a seat for a plurality of cooking accessories, or for a smaller cooking grate configured to provide a continuous grated cooking surface in combination with the cooking grate featuring an opening. The flanges defining a seat for accessories may extend along all sides of the perimeter of the opening or along two parallel sides of the opening.

Cooking accessories may be adapted for placement onto the seat of the optional cooking grate opening. For example, a griddle member, sear grid, or pizza stone matching the dimensions of the grate opening may be set onto the seat of the optional cooking grate opening, forming a continuous cooking surface with the balance of the cooking grate. Other cooking accessories, such as a grill pan or wok, may be configured to for placement onto the seat of the optional cooking grate opening by virtue of the dimensions of the bottom surface of the accessory, which conforms to the dimensions of the opening such that the bottom edges of the accessory may be set upon the seat of the opening.

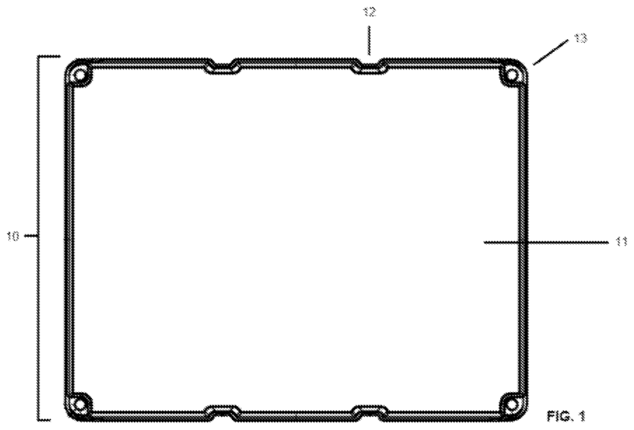

Referring now to the drawing wherein like numerals refer to like parts in the various views, FIG. 1 is a top view of an exemplary solid member 10 capable of receiving a grilling grate, receiving wood chips for smoking, and acting as a griddle cooking surface.

As seen in FIGS. 1, 2, and 5 the upper side of an exemplary solid metal member 10 includes a heat transfer zone 11, notches 12 disposed in the perimeter surface, and rounded openings 13 capable of receiving rounded pegs extending from the bottom surface of a cooking grate.

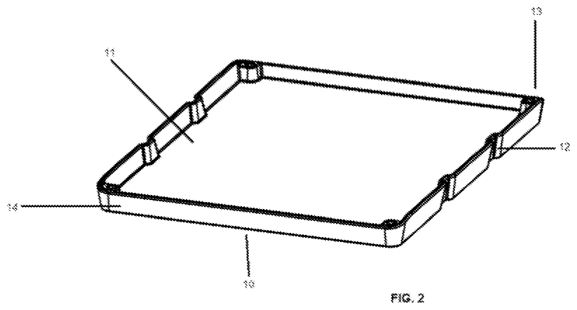

FIG. 2 is a perspective view of an exemplary solid member illustrating a raised perimeter wall 14 with a plurality of notches 12 disposed along two opposing perimeter edges. Rounded openings 13 disposed in the corners of the perimeter walls are capable of receiving rounded projections extending downward from a grated cooking surface.

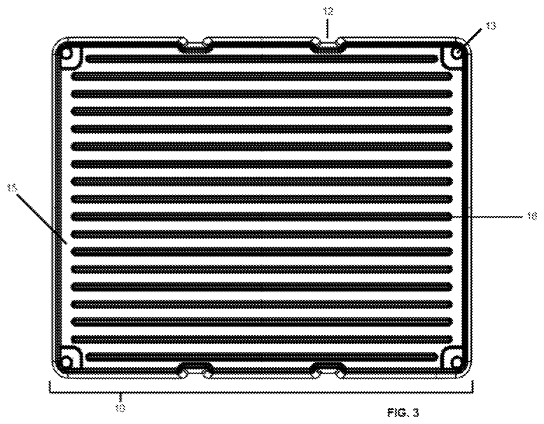

FIG. 3 is a bottom view of an exemplary solid member 10 with raised ridges 16 extending from a planar cooking surface 15.

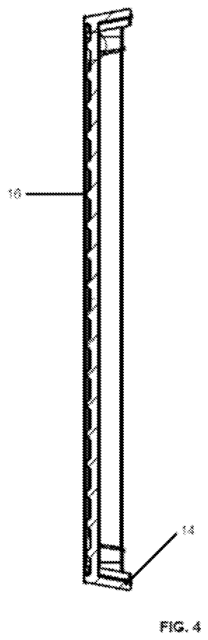

FIG. 4 is a cut away lateral view showing raised ridges 16 extending from the cooking surface of the underside of the solid metal member. A perimeter wall 14 extends from the perimeter of the upper side of the solid metal member.

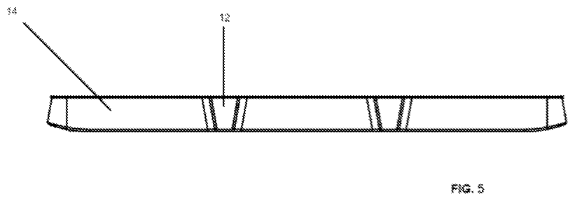

FIG. 5 is a lateral view of the perimeter wall 14 with notches 12 disposed therein. FIG. 5 further illustrates the decreasing lateral width of the notches 12 from the upper side of the member to the underside.

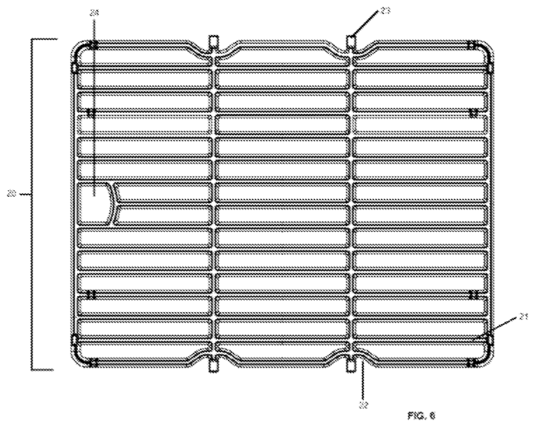

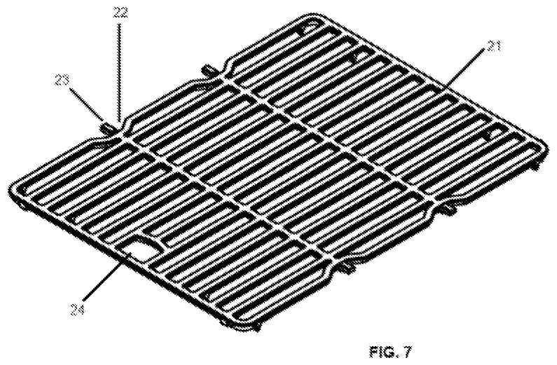

As seen in FIGS. 6 and 7, a planar cooking grate 20 is defined by a plurality of metal bars 21 arranged in parallel at regular intervals. In this exemplary, non-limiting embodiment, a pair of metallic bars are disposed in perpendicular fashion to the parallel bars with extensions 23 extending beyond the perimeter edge of the grate 20.

FIGS. 6 and 7 illustrate an opening 24 disposed in the grate to allow the grate to be lifted when not in use for cooking.

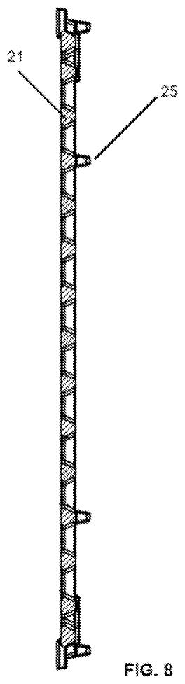

FIG. 8 is a cut away lateral view of the exemplary grate member showing the optional shape of the bars 21 of the cooking grate and the pegs 25 extending downward from the cooking surface of the cooking grate.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A cooking system comprising:
a solid metal member adapted for placement in overlying relation to a heat source, the solid member including an upper side and underside, the upper side defining a heat transfer zone, with side walls extending upwardly from the perimeter of the upper side;
a metal grate adapted for placement in overlying relation to said solid metal member, the metal grate defining a cooking surface.

2. The cooking system as recited in claim 1, wherein said solid metal member and metal grate are rectangular.

3. The cooking system as recited in claim 1, wherein the underside of said solid metal member includes a plurality of raised metal ridges extending from the surface.

4. The cooking system as recited in claim 1, wherein a plurality of openings are disposed near the perimeter of the upper side of said solid metal member corresponding to metallic pegs extend downward from the metal grate.

5. The cooking system as recited in claim 1, wherein a plurality of openings are disposed near the perimeter of the underside of said solid metal member corresponding to metallic pegs extend downward from the metal grate.

6. The cooking system as recited in claim 5, wherein said notches decrease in lateral width from the upper side of said metal member to the underside.

7. The cooking system as recited in claim 1, wherein an opening with a length and width of at least 2.5 cm is disposed in the surface of the cooking grate.

8. The cooking system as recited in claim 1, wherein a rectangular opening with a length and width of at least 10 cm is disposed in the surface of said cooking grate, a plurality of flanges extending no more than 2 cm laterally from the underside of the cooking grate on at least two sides of the rectangular opening, said flanges being adapted to support cooking accessories and a cooking grate.

9. A cooking system comprising:
a rectangular solid metal member adapted for placement in overlying relation to a heat source, the solid member including an upper side and underside, the upper side defining a heat transfer zone, with side walls extending upwardly from the perimeter of the upper side, wherein the underside of said solid metal member includes a plurality of raised metal ridges extending from the surface;
a rectangular metal grate adapted for placement in overlying relation to said solid metal member, the metal grate defining a cooking surface, wherein an opening with a length and width of at least 2.5 cm is disposed in the surface of the cooking grate;
wherein a plurality of openings are disposed near the perimeter of the upper side of said solid metal member corresponding to metallic pegs extending downward from the metal grate and a plurality of notches are disposed in the perimeter side wall of said solid metal member corresponding to metallic bars extending laterally from the metal grate, wherein said notches decrease in lateral width from the upper side of said metal member to the underside.

10. The cooking system as recited in claim 9, wherein a rectangular opening with a length and width of at least 10 cm is disposed in the surface of said cooking grate, a plurality of flanges extending no more than 2 cm laterally from the underside of the cooking grate on at least two sides of the rectangular opening, said flanges being adapted to support cooking accessories and a cooking grate.

11. A cooking system comprising:
a rectangular solid metal member adapted for placement in overlying relation to a heat source, the solid member including an upper side and underside, the upper side defining a heat transfer zone, with side walls extending upwardly from the perimeter of the upper side, wherein the underside of said solid metal member includes a plurality of raised metal ridges extending from the surface;
a rectangular metal grate adapted for placement in overlying relation to said solid metal member, the metal grate defining a cooking surface, wherein a rectangular opening with a length and width of at least 10 cm is disposed in the surface of said cooking grate, a plurality of flanges extending no more than 2 cm laterally from the underside of the cooking grate on at least two sides of the rectangular opening, said flanges being adapted to support cooking accessories and a cooking grate;
wherein a plurality of openings are disposed near the perimeter of the upper side of said solid metal member corresponding to metallic pegs extending downward from the metal grate and a plurality of notches are disposed in the perimeter side wall of said solid metal member corresponding to metallic bars extending laterally from the metal grate, wherein said notches decrease in lateral width from the upper side of said metal member to the underside.
